(19) United States
(12) Patent Application Publication
(10) Pub. No.: US 2020/0226308 A1
(43) Pub. Date: Jul. 16, 2020

(54) OBTENTION OF AN IMPACT RESISTANT GLAZING

(71) Applicant: SAINT-GOBAIN GLASS FRANCE, COURBEVOIE (FR)

(72) Inventors: Jean-Charles SAUVESTY, SULLY SUR LOIRE (FR); Carole FREDY, NOGENT SUR MARNE (FR)

(21) Appl. No.: 16/624,159

(22) PCT Filed: Jun. 7, 2018
(86) PCT No.: PCT/EP2018/064992

§ 371 Date: Dec. 18, 2019

(30) Foreign Application Priority Data
Jun. 22, 2017 (FR) 1755709

(51) Int. Cl. G06F 30/23; B64F 5/60; G06F 30/15

(52) U.S. Cl. CPC G06F 30/23; G06F 2113/24; G06F 30/15; B64F 5/60

(57) ABSTRACT

A process to obtain a glazing which withstands a dynamic impact when it is installed in a structure, such as a bird strike for a glazing installed in an aircraft, the glazing including at least one glass sheet, the process including with the aid of a finite-element numerical model of the glazing installed in the structure and subjected to the impact, using a law of behavior of the constituent material of each glass sheet, the maximum stress envelope on each glass sheet of the glazing is calculated; and for each glass sheet of the glazing, the maximum stress envelope is compared to the fracture stress of the glass sheet obtained according to an experimental method for determining the fracture stress of a glass sheet selected as a function of the type of impact.

The present invention relates to a nondestructive process for validating that a glazing installed in a structure withstands a dynamic impact, such as a bird strike for an aircraft glazing. The invention also relates to a process for manufacturing a glazing so that it withstands a dynamic impact.

Within the meaning of the invention, the term “glazing” is understood to mean a structure comprising at least one glass sheet. Furthermore, the term “laminated glazing” is understood to mean a glazing structure comprising a stack of at least one glass sheet and one polymer interlayer, including a stack of a single glass sheet and a single polymer interlayer assembled together.

Within the context of the invention, a glass sheet is a rigid transparent substrate, which may be made of mineral glass or made of organic glass. A polymer interlayer is an interlayer sheet based on polymer material, in particular that is thermoformable or pressure-sensitive, i.e. the type of sheet that is used as an interlayer in laminated glazings. It may be a monolithic interlayer or a composite interlayer constituted by the assembly of several polymer components in the form of layers, resins or films.

It is known to test the impact resistance of vehicle glazings via standardized destructive tests with impactors representative of real situations, such as a bird test in the aeronautical field for airplane or helicopter glazings, a paving block test for train glazings, a ballistic test for armored vehicle glazings. Such destructive tests are expensive, in particular in that they require labor and the scrappage of the glazings tested in the event of breakage. Furthermore, they do not make it possible to optimize the composition and the integration of the glazings in a structure, in particular as a function of the stiffness of the materials of the glazing or of the attachment systems. This often results in an oversizing of the glazings, i.e. excessively large thicknesses of the glass sheets, and optionally of the polymer interlayers in the case of laminated glazings, relative to the levels of mechanical stresses likely to be applied to the glazings. Hence, the cost and the mass of the glazings are not optimized.

It is these drawbacks that the invention more particularly intends to resolve by providing a nondestructive process for validating that a glazing installed in a structure withstands a dynamic impact, and a process for manufacturing a glazing that guarantees the obtention of a glazing that is optimized simultaneously in terms of mass, cost and resistance to an impact.

For this purpose, one subject of the invention is a nondestructive process for validating that a glazing installed in a structure withstands a dynamic impact, such as a bird strike for a glazing installed in an aircraft, the glazing comprising at least one glass sheet, characterized in that it comprises steps wherein:
with the aid of a finite-element numerical model of the glazing installed in the structure and subjected to the impact, using a law of behavior of the constituent material of each glass sheet, the maximum stress envelope on at least one critical glass sheet of the glazing is calculated (preferably, the maximum stress envelope on each glass sheet of the glazing is calculated);
for at least the critical glass sheet of the glazing (preferably for each glass sheet of the glazing), the maximum stress envelope is compared to the fracture stress of the glass sheet obtained according to an experimental method for determining the fracture stress of a glass sheet selected as a function of the type of impact, in particular it is verified whether the maximum stress envelope is strictly lower than the fracture stress.

According to one aspect of the invention, the process is a nondestructive process for validating that a laminated glazing installed in a structure withstands a dynamic impact, the laminated glazing comprising a stack of at least one glass sheet and one polymer interlayer, the process comprising the steps wherein:
with the aid of a finite-element numerical model of the laminated glazing installed in the structure and subjected to the impact, using a law of behavior of the constituent material of each glass sheet, a law of behavior of the constituent material of each polymer interlayer, and a law of behavior of each interface between a glass sheet and a polymer interlayer, the maximum stress envelope on at least one critical glass sheet of the laminated glazing is calculated (preferably, the maximum stress envelope on each glass sheet of the laminated glazing is calculated);
for at least the critical glass sheet of the laminated glazing (preferably for each glass sheet of the laminated glazing), the maximum stress envelope is compared to the fracture stress of the glass sheet obtained according to an experimental method for determining the fracture stress of a glass sheet selected as a function of the type of impact, in particular it is verified whether the maximum stress envelope is strictly lower than the fracture stress.

Another subject of the invention is a process for manufacturing a glazing so that it withstands a dynamic impact when it is installed in a structure such as a bird strike for a glazing installed in an aircraft, the glazing comprising at least one glass sheet, characterized in that it comprises steps wherein:
with the aid of a finite-element numerical model of the glazing installed in the structure and subjected to the impact, using a law of behavior of the constituent material of each glass sheet, the maximum stress envelope on at least one critical glass sheet of the glazing is calculated (preferably, the maximum stress envelope on each glass sheet of the glazing is calculated), as a function of the dimensions of the glazing;
the characteristics of the glazing are adjusted among its dimensions, and the constituent material of each glass sheet, so that the maximum stress envelope calculated for at least the critical glass sheet of the glazing (preferably for each glass sheet of the glazing) is strictly lower than the fracture stress of the glass sheet obtained according to an experimental method for determining the fracture stress of a glass sheet selected as a function of the type of impact, while having an optimized sizing of the glazing;
each glass sheet of the glazing with the adjusted characteristics is prepared and assembled.

According to one aspect of the invention, the process is a process for manufacturing a laminated glazing so that it withstands a dynamic impact when it is installed in a structure, the laminated glazing comprising a stack of at least one glass sheet and one polymer interlayer, the process comprising steps wherein:
with the aid of a finite-element numerical model of the laminated glazing installed in the structure and subjected to the impact, using a law of behavior of the constituent material of each glass sheet, a law of behavior of the constituent material of each polymer interlayer, and a law of behavior of each interface between a glass sheet and a polymer interlayer, the maximum stress envelope on at least one critical glass sheet of the laminated glazing is calculated (preferably, the maximum stress envelope on each glass sheet of the laminated glazing is calculated), as a function of the dimensions of the laminated glazing;
the characteristics of the laminated glazing are adjusted among its dimensions, the constituent material of each glass sheet, the constituent material of each polymer interlayer, and the nature of each interface between a glass sheet and a polymer interlayer, so that the maximum stress envelope calculated for at least the critical glass sheet of the laminated glazing (preferably for each glass sheet of the laminated glazing) is strictly lower than the fracture stress of the glass sheet obtained according to an experimental method for determining the fracture stress of a glass sheet selected as a function of the type of impact, while having an optimized sizing of the laminated glazing;
each glass sheet and each polymer interlayer of the laminated glazing with the adjusted characteristics is prepared and assembled.

Within the context of the invention, the expression “critical glass sheet” is understood to mean a glass sheet of the glazing which is known to be the most likely to break during the dynamic impact, for example due to its thickness, its constituent material, its positioning with respect to the impactor, etc. The invention may then be implemented by calculating the maximum stress envelope on this critical glass sheet only. However, in one preferred embodiment of the invention, the maximum stress envelope on each glass sheet of the glazing is calculated.

Within the meaning of the invention, the expression “dimensions of the glazing” is understood to mean not only its peripheral dimensions, for example in the case of a rectangular glazing, its width and its length, but also the thicknesses of its glass sheet(s) and, in the case of the laminated glazing, of its constituent polymer interlayer(s). Furthermore, the expression “optimized sizing of the glazing” is understood to mean the fact of having a thickness of glass and optionally a thickness of polymer interlayer in the glazing that are adjusted in order to minimize the mass and/or the cost of the glazing.

Within the context of the invention, the or each glass sheet of the glazing may be a sheet of mineral glass, in particular an oxide glass such as a silicate, borate, sulfate, phosphate, or other. Each glass sheet of the glazing which is made of mineral glass is advantageously reinforced, in particular by a thermal tempering process or by an ion-exchange process also referred to as “chemical tempering”.

In a known manner, the thermal tempering and chemical tempering processes make it possible to increase the impact resistance of the mineral glass sheets, by creating a surface zone under compression and a central zone under tension. In the case of chemical tempering, the surface substitution of an ion of the glass sheet (generally an alkali metal ion such as sodium or lithium) by an ion of larger ionic radius (generally an alkali metal ion such as potassium or sodium) makes it possible to create, at the surface of the glass sheet, residual compressive stresses, down to a certain depth. Throughout the text, a depth corresponds, along a cross section, to a distance between a point considered and a surface of the glass sheet, measured along a normal to said surface. The stresses are parallel to the surface of the glass sheet, and are thickness stresses, in the sense that, with the exception of the edge zones, the average of the stresses throughout the thickness of the glass sheet is zero. The surface compressive stresses are in fact balanced by the presence of a central zone under tension. Therefore, there is a certain depth at which the transition between compression and tension occurs, this depth being referred to as “compression depth P” in the remainder of the text.

Within the context of the invention, the or each glass sheet of the glazing may also be a sheet of organic glass, containing one or more organic polymer substances of high molecular weight, for example made of polycarbonate (PC) or of polymethyl methacrylate (PMMA).

Furthermore, in the case of a laminated glazing, the or each polymer interlayer of the laminated glazing may be a thermoformable or pressure-sensitive sheet, in particular based on polyvinyl butyral (PVB), polyurethane (PU), ethylene-vinyl acetate (EVA), polyethylene terephthalate (PET) or polyvinyl chloride (PVC).

According to the invention, a dynamic impact between a glazing and an impactor is considered, where the relative speed between the glazing and the impactor is between 15 m/s and 1500 m/s.

The impactor may be of varied nature, in particular the impactor may be a hard element such as a steel ball, a projectile of paving block type, a ballistic projectile, or else the impactor may be a soft element such as a bird. It may also be an impactor of fluid type, for example a pressurized gas in the case of a glazing subjected to an explosive impact, or else a volume of sprayed water in the case of a glazing subjected to an impact with a lot of water, in particular for marine applications.

As nonlimiting examples of impacts that can be envisaged within the context of the invention, mention may be made of the following impacts, corresponding to standardized tests:
a bird strike, used for testing glazings of aircraft (airplanes, helicopters), where the impactor is a chicken of 0.5 kg to 2 kg and the relative speed between the glazing and the impactor is between 50 m/s and 200 m/s;
an impact with a UIC (Union Internationale des Chemins de fer or International Union of Railways) projectile used for testing train glazings according to the European railway standard, where the impactor is the UIC projectile and the relative speed between the glazing and the impactor is between 20 m/s and 220 m/s;
a glass bottle impact, used for testing train glazings, where the impactor is a glass bottle and the relative speed between the glazing and the impactor is between 25 m/s and 180 m/s;
an impact of gravel type, used for testing train glazings, where the impactor is a 20 g aluminum element having a pointed head and the relative speed between the glazing and the impactor is between 25 m/s and 150 m/s;
a hailstone impact, used for testing glazings of aircraft (airplanes, helicopters), where the impactor is an assembly of cotton and frozen water of predefined diameter (10 mm; 12.7 mm; 25.4 mm; 50.8 mm) and the relative speed between the glazing and the impactor is between 40 m/s and 260 m/s;
a ballistic impact, used for testing glazings of armored vehicles, where the impactor is a ballistic projectile that may be of various shapes and of various calibers and the relative speed between the glazing and the impactor is between 350 m/s and 1000 m/s.

According to one feature, the finite-element numerical model is obtained by carrying out a meshing of geometric models of the impactor, on the one hand, and of the glazing with the surrounding elements that hold it in position in the structure, on the other hand.

These geometric models may in particular be produced using computer-aided drafting (CAD) or computer-aided design (CAD) software, such as the AUTOCAD, CATIA, PRO-ENGINEER/CREO or SOLIDWORKS software.

Advantageously, the meshing of the geometric models of the impactor and of the glazing with its surrounding elements, and also the calculation of the maximum stress envelope on each glass sheet of the glazing, are carried out with the aid of finite-element analysis software, such as the ABAQUS, ANSYS or RADIOSS software.

According to one aspect of the invention, provided as input, for the finite-element calculation, are the properties of the materials of the impactor, of the glazing and of its surrounding elements over at least the ranges of frequencies and temperatures characteristic of the impact.

According to another aspect of the invention, provided as input, for the finite-element calculation, are the characteristics of the dynamic impact, in particular the site and angle of impact of the impactor on the glazing, the relative speed between the glazing and the impactor, the mass of the impactor, and the temperature of each component.

Irrespective of the embodiment, a process according to the invention comprises:
setting up a finite-element numerical model of the impactor and of the glazing with the surrounding elements that hold it in position in the structure,
injecting into the finite-element numerical model properties of the materials of the impactor, of the glazing and of its surrounding elements, over at least the ranges of frequencies and temperatures characteristic of the impact,
injecting into the finite-element numerical model characteristics of the dynamic impact, in particular the site and angle of impact of the impactor on the glazing, the relative speed between the glazing in the impactor, the mass of the impactor, the temperature of each component,
selecting an experimental method for determining the fracture stress of a glass sheet corresponding to the type of impact, and obtaining the fracture stress of each glass sheet of the glazing according to the method selected, in order to compare it with the maximum stress envelope on this glass sheet calculated with the aid of the finite-element numerical model.

An important step of the invention is the selection of an experimental method for determining the fracture stress of a glass sheet corresponding to the type of impact, i.e. in which the impactor stresses the glass sheet in a manner similar to what happens during the real impact. In particular, the method selected must be representative of the type of stresses of the critical defects present in the glass sheet, which may depend in particular on the composition of the glass, on the type of treatment applied to the glass (thermal tempering, chemical tempering, etc.), on the type of impactor, on the impact speed. Thus, for example, the method selected will not be the same for an airplane glazing subjected to a bird strike, for a train glazing subjected to a paving block impact, or else for a motor vehicle glazing subjected to a ballistic impact.

Examples of experimental methods for determining the fracture stress of a glass sheet include, in particular: a drop tower impact test; a ring-on-tripod flexural test without indentation; a ring-on-tripod flexural test after indentation.

In the drop tower impact test; an impact of a rigid impactor, which is a steel ball, is carried out on a test specimen of the glass sheet previously instrumented with strain gauges. The steel ball is positioned at various heights, until the test specimen fractures. At the same time, a finite-element numerical model of the test is carried out, by modeling the strain gauges in the numerical model. In the actual test, the dynamic strains are measured by means of the strain gauges in order to validate the numerical model, which makes it possible to determine the stress at the start of breaking, which corresponds to the fracture stress of the glass sheet. In practice, two strain gauges are used for each test, which makes it possible to see the centering of the ball with respect to the center of the test specimen. On the basis of the calculations of the finite-element numerical model, a graph is plotted that gives the stress at the start of breaking as a function of the drop height for various ball diameters. It is thus possible to deduce, as a function of the results of the tests, the probability of fracture for a given stress. Advantageously, in the drop tower impact test, the glass sheet is stressed dynamically, which is comparable to what happens during a bird strike, an impact with a UIC projectile, or a ballistic impact for example.

According to particular embodiments of the invention:
the glazing is a glazing intended to be installed in an aircraft, the impact is a bird strike and the method selected for determining the fracture stress of the glass sheet is a drop tower impact test,
the glazing is a glazing intended to be installed in a train, the impact is an impact with a UIC projectile and the method selected for determining the fracture stress of the glass sheet is a drop tower impact test,
the glazing is a glazing intended to be installed in a motor vehicle, the impact is a ballistic impact and the method selected for determining the fracture stress of the glass sheet is a drop tower impact test.

In the ring-on-tripod flexural test without indentation, an increasing force is applied to a test specimen of the glass sheet placed between three balls and a ring, until the test specimen fractures. This test makes it possible to determine the fracture stress of defects at the surface of test specimens while avoiding the edges owing to the location of the maximum stress situated under the ring. Furthermore, the stress is constant and isotropic (equal in all directions) under the loading ring. In practice, any one face of each test specimen is coated with an adhesive film on a face that will subsequently be placed under compression. The role of this film is to enable the location of the origin of fracture. The ring-on-tripod flexural test is carried out for example with the aid of an Instron 5567 machine, controlled with a crosshead descent rate of 2 mm/min, equipped with a 10 kN load cell, a 10 mm-diameter ring with a torus having a radius of 1 mm, attached at the end of the Instron machine, and a stand to which three balls having a radius of 5 mm are bonded, positioned at 120° around a circle having a radius of 20 mm and the center of which is coincident with the center of the ring. The test specimen is placed between these three balls and the ring. An increasing force is then applied to the ring until the test specimen fractures. Only test specimens for which the origin of fracture is under the ring are counted. The fracture stress as a function of the force at fracture and of the thickness of the test specimen is given by the following formula, the result being taken as the average of five tests:

$${σ}_{( MPa )} = \frac{0.8 \; 47 \times {Force}_{( N )}}{{thickness}_{( m m )}^{2}} .$$

In the ring-on-tripod flexural test after indentation, the flexural test is carried out as above, except that the test specimens were subjected beforehand to an indentation, made on the face opposite the adhesive film using weights placed on top of a Vickers tip. For the indentation, each test specimen is positioned under the tip so that the indentation is created in the middle of the test specimen, to within 1 mm. The tip is lowered onto the test specimen for example using an Instron machine equipped with a 5 kN load cell. In the initial position, the tip is placed between 2 and 5 mm above the test specimen. Then the tip is brought towards the glass at a speed of 10 mm/min. After contact between the tip and the glass, the force applied by the machine becomes zero and only the weights placed on the tip give rise to the indentation of the glass. The indentation lasts 20 seconds, then the tip is raised by the machine. The glass is then stored for at least 12 hours in order to stabilize the propagation of the cracks. In the event of fracture after indentation but before the flexural test, the flexural fracture stress is declared to be zero. For the flexural test, the test specimen is then placed between the three balls and the ring so that the indentation mark is aligned with the center of the ring, to within 1 mm.

For a mineral glass sheet, the evolution of the probability of fracture as a function of the stress obtained according to the drop tower impact test or the ring-on-tripod flexural test after or without indentation may depend on the volume of the test specimen tested. Specifically, the mechanical strength of the mineral glass sheet is set by the largest defect in the stressed zone. By changing the stress conditions or by taking a larger test specimen, there is a greater probability of encountering a greater defect. In order to take into account this phenomenon, use is then made of a statistical method based on the Weibull model.

In this model, a cumulative probability of fracture PRi is expressed as a function of the applied stress σR. By carrying out the same type of test N times, and if the fracture stresses are arranged in ascending order: σR1<σR2<<σRi < . . . <σRN, it is then possible to define a cumulative probability of fracture PRᵢ associated with the i-th fracture stress σRi by:

$$P {R}_{i} = \frac{i}{N + 1} ,$$

where i is the rank of the sample and N the total number of test specimens, which must be greater than 20 in order to have a reasonable value of the Weibull modulus. The probability of survival Ps of the test specimen subjected to a stress is:

$${P}_{s} = {e}^{- \frac{V}{{V}_{0}} {( \frac{σ}{{σ}_{0}} )}^{m}} = 1 - P {R}_{i} ,$$

where m is the Weibull modulus characterizing the distribution of the fracture stresses, σ₀ and V₀ are constants and V is the volume of the test specimen.

However, the inventors have demonstrated that, for a mineral glass sheet reinforced by chemical tempering such as those used in airplane glazings, the ring-on-tripod flexural test after indentation makes it possible to dispense with the statistical aspect of the fracture of the glass if a suitable indentation depth is chosen. For this, the indentation depth is chosen as greater than the largest defect size of the glass, in order to create a greater defect than the intrinsic defects of the glass, smaller than the compression depth P resulting from the chemical tempering, in order to have a measured fracture stress which remains representative of the fracture stress of the reinforced glass, with little dispersion. Under these conditions, the ring-on-tripod flexural test after indentation is highly representative of the stresses of the critical defects of the glass generated during a dynamic impact, such as a bird strike, an impact with a UIC projectile, a ballistic impact, etc. Furthermore, as a defect is created that is greater than the intrinsic defects of the glass, there is no longer a problem of change of scale for the probability of fracture.

Thus, according to one advantageous embodiment of the invention, the glazing comprises at least one mineral glass sheet reinforced by chemical tempering and the method selected for determining the fracture stress of the glass sheet is a ring-on-tripod flexural test after indentation.

Preferably, the indentation depth is chosen as greater than the largest defect size of the glass and smaller than the compression depth P resulting from the chemical tempering. In particular, according to one example, the indentation depth is of the order of 5 to 25 μm for a compression depth P of the order of 200 to 250 μm.

In practice, the evolution of the probability of fracture as a function of the stress is established from results of the ring-on-tripod flexural test after indentation. A significant advantage is that, in this case, the evolution of the probability of fracture as a function of the stress established for a given test specimen is valid for any glass sheet volume.

The value of the fracture stress, to which the maximum stress envelope on the glass sheet will be compared, may for example be chosen as being the stress value at 10% probability of fracture on the graph of evolution of the probability of fracture as a function of the stress. It is also possible to add a factor X (X>1), by considering that the ring-on-tripod flexural test after indentation is too conservative, given that a defect is added. The value of this factor X is chosen relative to the experiment and to the observations made on destructive tests.

In one embodiment, the glazing is a laminated airplane glazing consisting of a stack of three glass sheets and two polymer interlayers inserted between the glass sheets. Such a structure with three glass plies is a conventional structure for frontal, front lateral or back lateral airplane glazing.

In particular, an example of a conventional structure for a laminated airplane glazing is the following stack: mineral glass (3 mm)/PU (5.3 mm)/mineral glass (8 mm)/PVB (2 mm)/mineral glass (8 mm).

In another embodiment, the glazing is a laminated helicopter glazing consisting of a stack comprising at least one glass sheet and one polymer interlayer.

In particular, an example of a conventional structure for a laminated helicopter glazing is the following stack: mineral glass (0.7 mm)/PU (2.5 mm)/PMMA (7 mm), or else a stack of a single glass sheet and of a single composite polymer interlayer: mineral glass (3 mm)/PU (3.56 mm)+PET (0.18 mm). According to one aspect of the invention, in the case of a laminated glazing, the law of behavior of the constituent material of each polymer interlayer of the laminated glazing is a viscoelastic model determined from DMA (dynamic mechanical analysis) measurements. DMA is used to characterize the response of a material to temperature and to frequency, when applying small cyclical deformations. In practice, from results of DMA on a sample of the polymer interlayer, the shear properties of the material of the interlayer are studied by establishing:
the curve of evolution of the storage modulus G′ of the material as a function of the frequency for various temperatures, in particular the frequency is between 5 Hz and 285 Hz and the temperature is between −60° C. and +60° C.,
the curve of evolution of the loss modulus G″ of the material as a function of the frequency for various temperatures, in particular the frequency is between 5 Hz and 285 Hz and the temperature is between −60° C. and +60° C.

From these G′(f) and G″(f) data, a master curve is constructed for the storage G′ and loss G″ moduli over at least the ranges of frequencies and temperatures characteristic of the impact, using for example the frequency/temperature equivalence law established by the WLF (Williams-Landel-Ferry) method.

It is then possible to use the generalized Maxwell model, which makes it possible to describe the parameters of the materials according to a relaxation time distribution, in the form of a Prony series. The master curve established previously makes it possible to identify the parameters of the viscoelastic model of the constituent material of the polymer interlayer, by relating (or “fitting”) a Prony series to the master curve, in the form:

$$G ( t ) = {G}_{0} ( 1 - {\sum }_{k = 1}^{N} {g}_{k} ( 1 - {e}^{- \frac{t}{{τ}_{k}}} ) ) ,$$

with G₀ the (high frequency or low temperature) instantaneous module, gₖ the relative moduli, and τₖ the relaxation times.

Another subject of the invention is a glazing obtained by the manufacturing process as described above so as to withstand a given dynamic impact when it is installed in a given structure.

In one embodiment, at least some of the steps of the nondestructive process for validating that a glazing installed in a structure withstands a dynamic impact as described above or of the process for manufacturing a glazing so that it withstands a dynamic impact when it is installed in a structure as described above, are determined by computer program instructions.

Consequently, another subject of the invention is a computer program on a recording medium, this program being capable of being implemented in a terminal, or more generally in a computer, this program comprising instructions suitable for the implementation of all or some of the steps of a process as described above.

This program may use any programming language, and be in the form of source code, object code or code intermediate between source code and object code, for example in a partially compiled form.

Another subject of the invention is a computer-readable recording medium, comprising instructions of a computer program as mentioned above.

The recording medium may be any entity or device capable of storing the program. For example, the medium may comprise a storage means, such as a read-only memory, a rewritable nonvolatile memory, for example a USB key, an SD card, an EEPROM, or else a magnetic recording means, for example a hard disk.

The recording medium may also be an integrated circuit into which the program is incorporated, the circuit being suitable for executing, or for being used in the execution of, the process.

The recording medium may be a transmittable medium such as an electrical or optical signal, which may be transported via an electrical or optical cable, by radio or by other means. The program according to the invention may in particular be downloaded from a network such as the Internet.

Another subject of the invention is a terminal comprising a processing module configured for:
calculating, by finite element analysis, the maximum stress envelope on each glass sheet of a glazing installed in a structure and subjected to a dynamic impact, where the glazing comprises at least one glass sheet, with the aid of a finite-element numerical model of the glazing installed in the structure and subjected to the impact, using a law of behavior of the constituent material of each glass sheet, and also, in the case of a laminated glazing comprising a stack of at least one glass sheet and one polymer interlayer, a law of behavior of the constituent material of each polymer interlayer and a law of behavior of each interface between a glass sheet and a polymer interlayer, and
comparing the maximum stress envelope calculated for each glass sheet of the glazing to a fracture stress value of the glass sheet obtained according to an experimental method for determining the fracture stress of the glass selected as a function of the type of impact.

According to one embodiment, the processing module of the terminal is also configured for:
calculating, by finite element analysis, the maximum stress envelope on each glass sheet of the glazing as a function of the dimensions of the glazing, and
adjusting the dimensions of the glazing so that the maximum stress envelope calculated for each glass sheet of the glazing is strictly lower than a fracture stress value of the glass sheet, obtained according to an experimental method for determining the fracture stress of the glass selected as a function of the type of impact, while having an optimized sizing of the glazing.

According to one aspect, the processing module of the terminal according to the invention comprises a computer program as mentioned above, this program being recorded on a recording medium in accordance with the invention and formed by a rewritable nonvolatile memory of the terminal, the instructions of the program being able to be interpreted by a processor of the terminal.

The terminal, the computer program and the recording medium have, according to the invention, the same characteristics as the process according to the invention. The invention may be implemented with any type of terminal, for example a laptop or desktop computer.

A final subject of the invention is a system for validating, by finite element analysis, that a glazing installed in a structure withstands a dynamic impact, where the glazing comprises at least one glass sheet, the system comprising:
a graphical interface, configured for displaying a model of the impactor and a model of the glazing with its surrounding elements, providing input data for the finite element analysis and displaying results of the finite element analysis;
a module for modeling the materials of the impactor and of each glass sheet, and optionally of each polymer interlayer in the case of a laminated glazing, and of the surrounding elements, in order to define the properties of these materials over at least the ranges of frequencies and temperatures characteristic of the impact;
a module for modeling the impact, in order to define in particular the site and angle of impact of the impactor on the glazing, the relative speed between the glazing and the impactor, the mass of the impactor, and the temperature of each component;
a processing module, for preparing the finite-element numerical model of the glazing installed in the structure and subjected to the impact, carrying out the finite element analysis, and calculating the maximum stress envelope on each glass sheet of the glazing.

In such a system, the processing module uses the data defined in the module for modeling the materials and in the module for modeling the impact.

The features and advantages of the invention will become apparent in the description which follows of an example of implementation of a process according to the invention for obtaining a laminated airplane glazing which withstands a bird strike, given solely by way of example and with reference to the appended drawings in which:

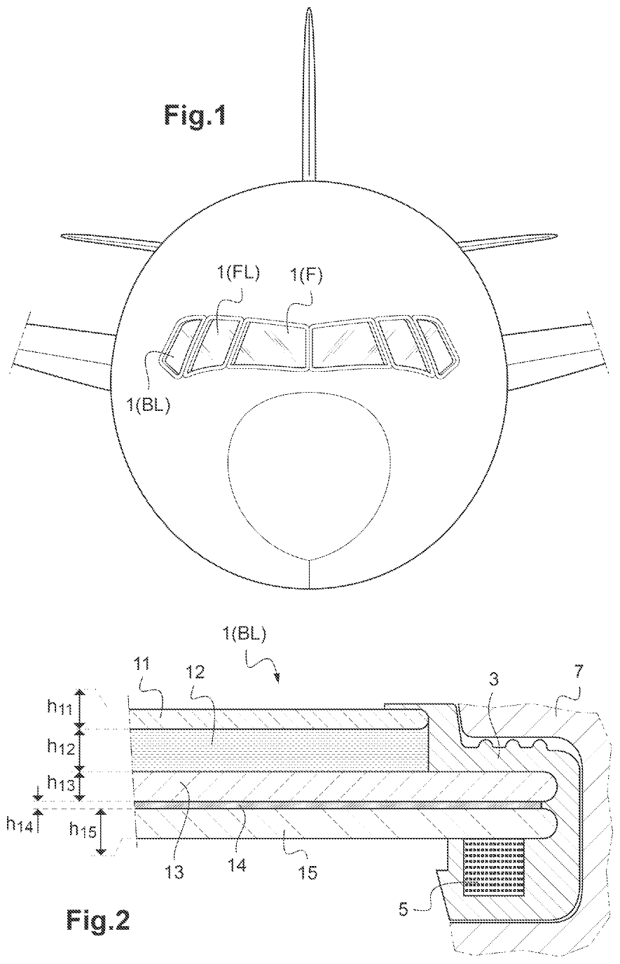

FIG. 1 is a schematic front view of an airplane cockpit comprising several laminated glazings or “windows”, respectively in the frontal 1(F), front lateral 1(FL) and back lateral 1(BL) position;

FIG. 2 is a partial schematic cross section of a back lateral 1(BL) laminated airplane glazing and of its surrounding elements when it is installed in the structure of an airplane cockpit, the laminated glazing consisting of a stack of three glass sheets and two polymer interlayers inserted between the glass sheets;

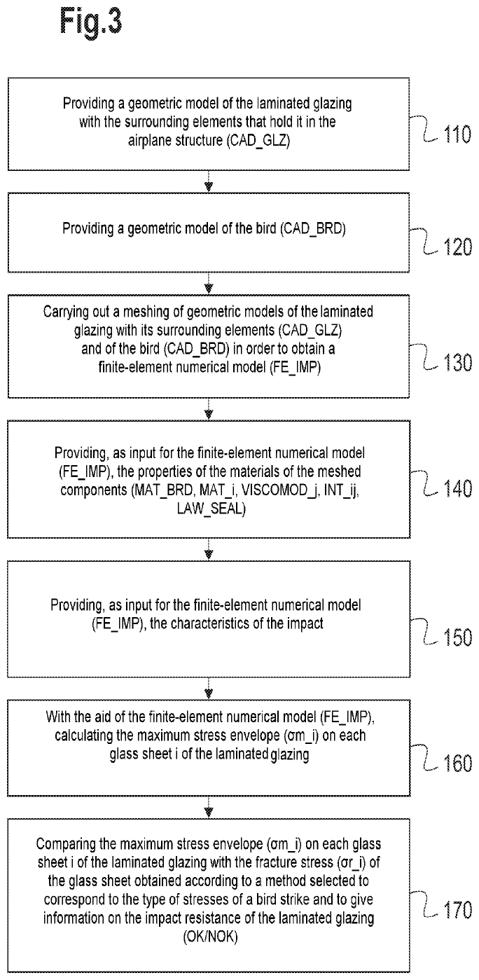

FIG. 3 is a schematic diagram showing the successive steps of a process according to the invention, carried out in order to evaluate whether the laminated glazing from FIG. 2 installed in the structure of the airplane withstands a bird strike;

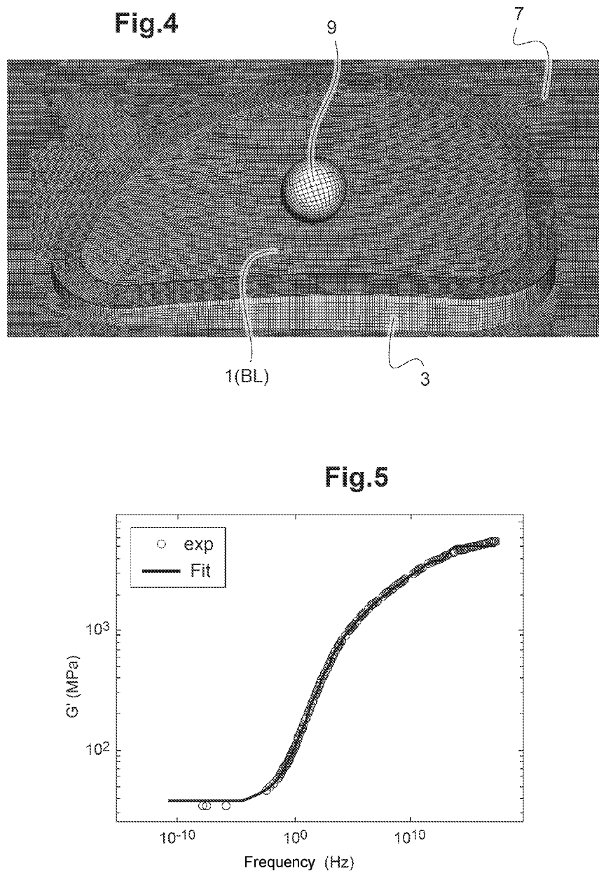

FIG. 4 is a meshed assembly intended to be used in a finite-element numerical model produced from CAD models of a bird and of the laminated glazing from FIG. 2 with its surrounding elements, during a bird strike at the center of the laminated glazing;

FIG. 5 is a graph showing the relating (or “fitting”) of a Prony series to the master curve of the storage modulus G′(f), obtained according to the invention for the PU polymer interlayer of the laminated glazing from FIG. 2;

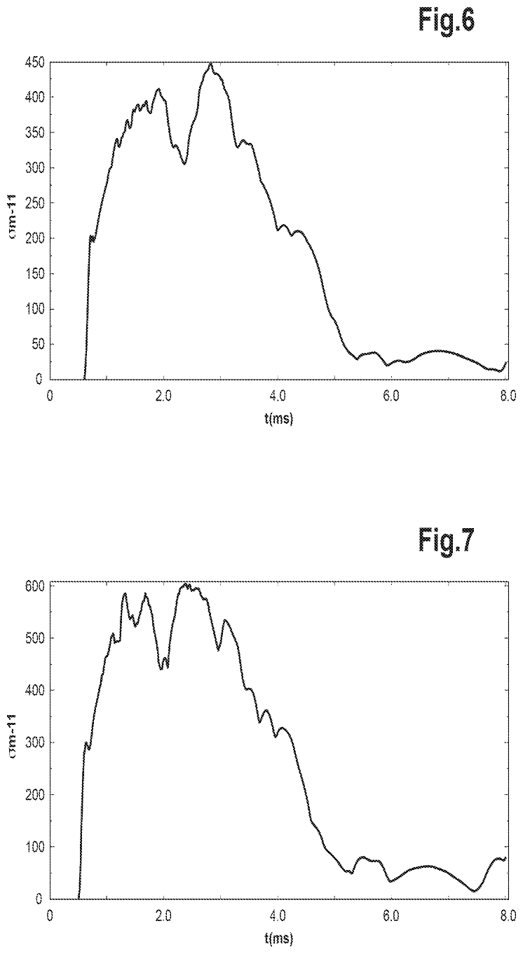

FIG. 6 is a graph showing the maximum stress envelope as a function of the time for a 3 mm-thick glass sheet of the laminated glazing from FIG. 2, as calculated with the aid of the finite-element numerical model, in a first configuration of bird strike on the laminated glazing;

FIG. 7 is a graph showing the maximum stress envelope as a function of the time for a 3 mm-thick glass sheet of the laminated glazing from FIG. 2, as calculated with the aid of the finite-element numerical model, in a second configuration of bird strike on the laminated glazing;

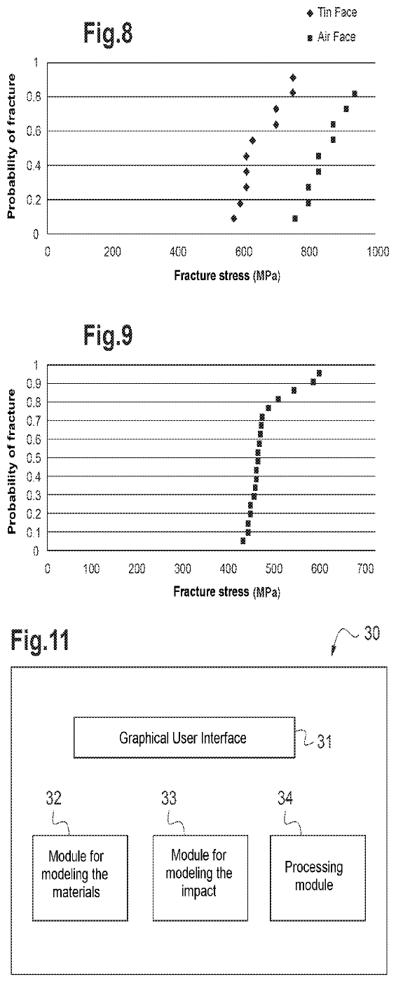

FIG. 8 is a graph representative of the probability of fracture of a glass sheet of the same glass composition and same reinforcement by chemical tempering as the glass sheets of the laminated glazing from FIG. 2 as a function of the stress, obtained according to the drop tower impact test, where the probability of fracture depends on the volume of the glass sheet and is given on the graph for a glass sheet of the same dimensions as the 3 mm-thick glass sheet of the laminated glazing;

FIG. 9 is a graph representative of the probability of fracture of a glass sheet of the same glass composition and same reinforcement by chemical tempering as the glass sheets of the laminated glazing from FIG. 2 as a function of the stress, obtained according to the ring-on-tripod flexural test after indentation, where the probability of fracture is independent of the volume of the glass sheet;

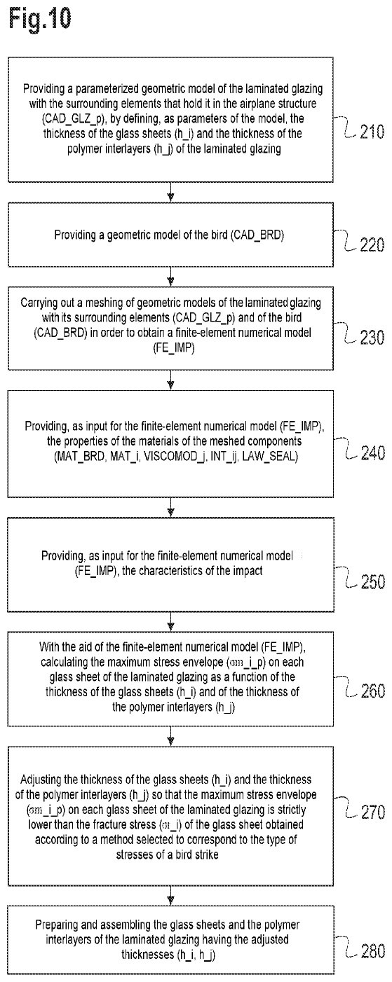

FIG. 10 is a schematic diagram showing the successive steps of a manufacturing process according to the invention, carried out in order to obtain the laminated glazing from FIG. 2 with an optimized sizing enabling it to withstand a bird strike when it is installed in the structure, while having a minimized mass and/or cost; and

FIG. 11 is a schematic diagram of a system for implementing a process according to the invention.

The process according to the invention is implemented in order to verify that a laminated glazing 1(BL), intended to be integrated into an airplane cockpit as back lateral window, withstands a bird strike in two different configurations (examples 1 and 2).

As is clearly visible in FIG. 2, the laminated glazing 1 consists of a stack of three glass sheets 11, 13, 15 and two polymer interlayers 12, 14 inserted between the glass sheets. Such a structure with three glass plies is a conventional structure for airplane cockpit laminated glazing.

Each glass sheet 11, 13, 15 is a sheet of aluminosilicate glass which has been reinforced by a chemical tempering process. For each glass sheet 11, 13, 15, the compression depth P resulting from the chemical tempering is of the order of 200 to 250 μm.

The polymer interlayer 12 is an interlayer sheet based on polyurethane (PU).

The polymer interlayer 14 is an interlayer sheet based on polyvinyl butyral (PVB).

The thicknesses h_i of the glass sheets i=11, 13, 15 and h_j of the polymer interlayers j=12, 14 are the following: glass (h₁₁=3 mm)/PU (h₁₂=5.3 mm)/glass (h₁₃=8 mm)/PVB (h₁₄=2 mm)/glass (h₁₅=8 mm).

FIG. 2 shows the laminated glazing 1 with its surrounding elements 3, 5, 7 that hold the laminated glazing 1 in position in the structure of the airplane. The laminated glazing 1 is connected to the structure 7 (or fuselage) of the airplane by means of a peripheral seal 3 made of silicone, which behaves mechanically as a ball joint between the structure 7 and the laminated glazing 1. A spacer 5 made of glass/epoxy composite is also provided on the inner periphery of the laminated glazing 1, in order to comply with the gap defined by the structure 7.

The laminated glazing 1 and its surrounding elements 3, 5, 7 are the same for both examples 1 and 2, which only differ from one another by the characteristics of the bird strike. The implementation of the process according to the invention, for verifying that the laminated glazing 1 integrated into the airplane cockpit withstands a bird strike, is the same for both examples 1 and 2. The process comprises the steps shown in the diagram from FIG. 3 and described below. It should be noted that the order of the steps from FIG. 3 is not imperative and may be subjected to any technically possible modification.

In steps 110 and 120, a geometric model CAD_GLZ of the laminated glazing 1 with its surrounding elements 3, 5, 7, and a geometric model CAD_BRD of the bird 9 are respectively provided. For examples 1 and 2, the geometric models CAD_BRD and CAD_GLZ were produced using the CATIA software.

In step 130, a meshing of the geometric models CAD_BRD and CAD_GLZ is carried out and a finite-element numerical model FE_IMP of the laminated glazing 1 installed in the structure 7 of the airplane and subjected to the impact with the bird 9 is obtained. For examples 1 and 2, the meshing of the geometric models CAD_BRD and CAD_GLZ was carried out using the HYPERMESH meshing tool and the coding was carried out using the ABAQUS EXPLICIT finite element computer code. FIG. 4 shows an example of a model obtained in step 130, comprising meshed representations of the bird 9 and of the laminated glazing 1 with its surrounding elements 3, 7.

In step 140, provided as input for the finite-element numerical model FE_IMP are the properties of the materials of the meshed components:
a law of behavior MAT_BRD of the constituent material of the bird, namely in this example a law of hydrodynamic behavior in the form of an equation of state, which is found in the scientific literature;
a law of behavior MAT_i of the constituent material of each glass sheet i=11, 13, 15, which are the same for the three glass sheets, namely in this example a density p=2450 kg/m³, a Young's modulus E=72 GPa, a Poisson's ratio v=0.23;
a law of behavior VISCMOD_j of the constituent material of each polymer interlayer j=12, 14, namely in this example a viscoelastic model which was determined for each polymer interlayer;
a law of behavior (INT_ij) of each interface between a glass sheet i=11, 13, 15 and a polymer interlayer j=12, 14, in particular in this example a perfect adhesion and a perfect contact between the surfaces are considered each time, so that the meshing is coincident;
a law of behavior LAW SEAL of the seal 3 and of the spacer 5, namely in this example, for the seal 3, a law of hyperelastic behavior of NEO HOOKE or VAN DER WAALS type and, for the spacer 7, a law of elastic behavior.

In examples 1 and 2, for each polymer interlayer j=12, 14, the viscoelastic model VISCMOD_j of the constituent material of the interlayer was determined by carrying out the following steps:
from DMA results on a sample of the interlayer j, the curve of evolution of the storage modulus G′(f) and the curve of evolution of the loss modulus G″(f) of the material of the interlayer j were established for a frequency between 5 Hz and 285 Hz and various isotherms between −60° C. and +60° C.;
from the data G′(f) and G″(f), a master curve was constructed for the storage G′ and loss G″ moduli, over ranges of frequencies and temperatures ranging from the glassy plateau to the rubbery plateau of the material, using the frequency/temperature equivalence law established by the WLF (Williams-Landel-Ferry) method;
the parameters of the viscoelastic model of the constituent material of the interlayer j were identified by relating a Prony series to the master curve, in the form:

$$G ( t ) = {G}_{0} ( 1 - {\sum }_{k = 1}^{N} {g}_{k} ( 1 - {e}^{- \frac{t}{{τ}_{k}}} ) ) ,$$

with G₀ the instantaneous modulus, gₖ the relative moduli, and τₖ the relaxation times.

FIG. 5 shows an example of “fitting” a Prony series to the master curve of the storage modulus G′(f) of the material of the PU polymer interlayer 12 of the laminated glazing 1.

In practice, the material data were defined in the format of the ABAQUS software, for example for the PU polymer interlayer 12 (the values are given in SI units):

*Material, name = PU_Visco
*Density
1070e−09,
*Elastic, moduli = LONG TERM
7e6, 0.49
*Viscoelastic, time = PRONY

| | | |
|---|---|---|
| 0.085, | 0., | 1e−10 |
| 0.075, | 0., | 1e−09 |
| 0.06, | 0., | 1e−08 |
| 0.063, | 0., | 1e−07 |
| 0.06, | 0., | 1e−06 |
| 0.054, | 0., | 1e−05 |
| 0.052, | 0., | 0.0001 |
| 0.037, | 0., | 0.001 |
| 0.024, | 0., | 0.01 |
| 0.01, | 0., | 0.1 |
| 0.0066, | 0., | 1. |
| 0.0019, | 0., | 10. |
| 0.0010, | 0., | 100. |
| 0.00097, | 0., | 1000. |

In step 150, provided as input for the finite-element numerical model FE_IMP are the characteristics of the impact, in particular:
site and angle of impact of the bird: at the center of the laminated glazing with the bird which is moving parallel to the trajectory of the airplane;
relative speed between the laminated glazing and the bird: 152.8 m/s for example 1 and 187.6 m/s for example 2;
mass of the bird: 1.807 kg for example 1 and 1.812 kg for example 2;
temperature of each component:
   for example 1, ambient T° C.: 25° C., T° C. of the inner face of the glazing 1: 20.4° C., T° C. of the outer face of the glazing 1: 23.9° C.,
   for example 2, ambient T° C.: 23° C., T° C. of the inner face of the glazing 1: 23° C., T° C. of the outer face of the glazing 1: 24.3° C.

In step 160, the maximum stress envelope σm_i on each glass sheet i=11, 13, 15 of the laminated glazing 1 is calculated by finite element analysis using the numerical model FE_IMP. In practice, for examples 1 and 2, use was made of the solver of the ABAQUS software for calculating the fields of stresses and strains induced by the bird strike on each glass sheet i=11, 13, 15 and each polymer interlayer j=12, 14 of the laminated glazing 1.

FIGS. 6 and 7 show, respectively for example 1 and for example 2, the maximum stress envelope σm_11 as a function of the time calculated using the numerical model FE_IMP for the 3 mm-thick glass sheet 11 of the laminated glazing 1.

In step 170, the maximum stress envelope σm_i on each glass sheet i=11, 13, 15 of the laminated glazing 1 is compared with the fracture stress σr_i of the glass sheet obtained according to a method selected to correspond to the type of stresses characteristic of a bird strike, and it is deduced whether the laminated glazing 1 withstands the impact in the bird strike configuration considered.

As explained above, the inventors have demonstrated that the drop tower impact test stresses the glass sheet in a manner similar to what happens during a bird strike. Hence, for examples 1 and 2, for each glass sheet i of the laminated glazing 1, the maximum stress envelope σm_i may be compared with the results of probability of fracture of a mineral glass sheet of the same glass composition, same reinforcement by chemical tempering and same volume as the glass sheet i as a function of the stress, obtained according to the drop tower impact test.

Thus, for the 3 mm-thick glass sheet 11 of the laminated glazing 1, it is possible to use the graph from FIG. 8 showing the probability of fracture of a mineral glass sheet of the same dimensions, same glass composition and same reinforcement as the sheet 11 as a function of the stress, obtained according to the drop tower impact test. Chosen, as value of the fracture stress σr_11, to which the maximum stress envelope σm_11 will be compared, is the stress value at 10% probability of fracture on the graph from FIG. 8, namely σr_11=590 MPa. For example 1, by comparing FIG. 6 with FIG. 8, it is observed that the maximum stress envelope σm_11 calculated using the numerical model FE_IMP for the glass sheet 11 remains, over time, always strictly lower than a value of 450 MPa, which is strictly lower than the fracture stress σr_11 of a 3 mm-thick glass sheet obtained according to the drop tower impact test. This makes it possible to validate that the glass sheet 11 of the laminated glazing 1 does not present a risk of breakage during the bird strike according to example 1. Moreover, a similar analysis (not illustrated in the figures) carried out for the 8 mm-thick glass sheets 13 and 15 of the laminated glazing 1 makes it possible to validate that the glass sheets 13 and 15 of the laminated glazing 1 do not present a risk of breakage either during the bird strike according to example 1. The laminated glazing 1 is therefore considered to be resistant to the bird strike according to example 1 (result: OK).

On the contrary, for example 2, by comparing FIG. 7 with FIG. 8, it is observed that the maximum stress envelope σm_11 calculated using the numerical model FE_IMP for the glass sheet 11 reaches, over time, a value of 600 MPa, which is greater than the fracture stress σr_11 of a 3 mm-thick glass sheet obtained according to the drop tower impact test. As a result, the glass sheet 11 of the laminated glazing 1 presents a risk of breakage during the bird strike according to example 2 and the laminated glazing 1 is considered to not be resistant to the bird strike according to example 2 (result: NOK).

As a variant, for examples 1 and 2, for each glass sheet i of the laminated glazing 1, it is also possible to compare the maximum stress envelope σm_i with the results of probability of fracture of a mineral glass sheet of the same glass composition and same reinforcement by chemical tempering as the glass sheet i and of any volume as a function of the stress, which are obtained according to the ring-on-tripod flexural test after indentation, by choosing an indentation depth greater than the maximum defect size of the glass and smaller than the compression depth P resulting from the chemical tempering.

In particular, for each of the glass sheets 11, 13, 15 of the laminated glazing 1, it is possible to use the graph from FIG. 9 showing the probability of fracture of a mineral glass sheet of the same glass composition and same reinforcement as a function of the stress, obtained according to the ring-on-tripod flexural test after indentation with an indentation depth of between 5 and 25 μm. Very advantageously, the graph from FIG. 9 may be used directly for each of the three glass sheets 11, 13, 15 of the laminated glazing 1, since in this case the probability of fracture is independent of the volume of the glass sheet. Chosen, as value of the fracture stress σr_i, to which the maximum stress envelope σm_i will be compared, is the stress value at 10% probability of fracture on the graph from FIG. 9, namely σr_i=450 MPa.

Here too, for example 1, by comparing FIG. 6 with FIG. 9, it is observed that the maximum stress envelope σm_11 calculated using the numerical model FE_IMP for the glass sheet 11 remains, over time, strictly lower than 450 MPa, which is the value of the fracture stress σr_11 obtained according to the ring-on-tripod flexural test after indentation. This makes it possible to validate that the glass sheet 11 of the laminated glazing 1 does not present a risk of breakage during the bird strike according to example 1. A similar analysis may be carried out for the glass sheets 13 and 15. The laminated glazing 1 is therefore considered to be resistant to the bird strike according to example 1 (result: OK).

On the contrary, for example 2, by comparing FIG. 7 with FIG. 9, it is observed that the maximum stress envelope σm_11 calculated using the numerical model FE_IMP for the glass sheet 11 reaches, over time, a value of 600 MPa, which is greater than the fracture stress σr_11 obtained according to the ring-on-tripod flexural test after indentation. As a result, the glass sheet 11 of the laminated glazing 1 presents a risk of breakage during the bird strike according to example 2 and the laminated glazing 1 is considered to not be resistant to the bird strike according to example 2 (result: NOK).

These results are highly consistent with the actual destructive bird tests carried out on the laminated glazing 1.

It emerges from the preceding examples that the fracture stress value determined according to the ring-on-tripod flexural test after indentation provides a harsher criterion than that determined according to the drop tower impact test. Specifically, with the ring-on-tripod flexural test after indentation, a defect is added to the glass, which results in overestimating the probability of fracture of the glass. It is then possible to add a factor X (X>1) to the stress value at 10% probability of fracture, this factor X being chosen empirically, by comparing to the observations made in the destructive tests.

FIG. 10 shows the steps of a process for manufacturing the laminated glazing 1 so that it withstands a bird strike when it is installed in an airplane cockpit. Here too, the order of the steps of FIG. 10 is not imperative and may be subjected to any technically possible modification.

Steps 220, 230, 240, 250 of the process from FIG. 10 are respectively identical to steps 120, 130, 140, 150 of the process from FIG. 3. The process from FIG. 10 differs from that of FIG. 3 in that:
in step 210, a geometric model CAD_GLZ_p of the laminated glazing 1 with its surrounding elements 3, 5, 7 is provided which is a parameterized model, by defining, as parameters of the model, the thickness h_i of the glass sheets i=11, 13, 15 and the thickness h_j of the polymer interlayers j=12, 14 of the laminated glazing 1;
in step 260, the maximum stress envelope σm_i_p on each glass sheet i=11, 13, 15 of the laminated glazing 1 is calculated by finite element analysis using the numerical model FE_IMP as a function of the thickness h_i of the glass sheets and of the thickness h_j of the polymer interlayers;
in step 270, the thickness h_i of the glass sheets and the thickness h_j of the polymer interlayers is adjusted so that the maximum stress envelope σm_i_p on each glass sheet of the laminated glazing is strictly lower than the fracture stress σr_i of the glass sheet obtained according to a method selected to correspond to the type of stresses characteristic of a bird strike;
in step 280, once the adjusted thickness h_i and h_j values have been calculated, the glass sheets i=11, 13, 15 and the polymer interlayers j=12, 14 having these adjusted thicknesses h_i, h_j are prepared, and they are assembled so as to form the laminated glazing 1.

Such a laminated glazing manufacturing process guarantees the obtention of a laminated glazing 1 that is optimized simultaneously in terms of mass, cost and resistance to impact in the bird strike configuration defined in step 250.

FIG. 11 shows a system 30 according to the invention, capable of being used for implementing the process described above in connection with FIG. 3 for verifying that the laminated glazing 1 integrated into an airplane cockpit as back lateral window withstands a bird strike, and/or the process described above in connection with FIG. 10 for manufacturing the laminated glazing 1 so that it withstands an impact a bird strike when it is installed in an airplane cockpit.

The system 30 comprises a graphical user interface 31, a module for modeling the materials 32, a module for modeling the impact 33 and a processing module 34.

With reference to FIGS. 3 and 10, the graphical interface 31 is configured to display the models of the impactor and of the laminated glazing with its surrounding elements obtained in steps 110/210, 120/220, 130/230; to provide input data in steps 140/240, 150/250; to display results of the finite element analysis in step 170/270. The module for modeling the materials 32 is configured to store and manage the material data provided in step 140/240. The module for modeling the impact 33 is configured to store and manage the data characteristic of the impact provided in step 150/250. The processing module 34 is configured to prepare the finite-element numerical model FE_IMP in step 130/230; to carry out the finite element analysis and to calculate the maximum stress envelope σm_i, σm_i_p in step 160/260 and, in the case of the process from FIG. 10, the adjusted thickness h_i and h_j values in step 270. For the finite element analysis, the processing module 34 uses the data defined in the module for modeling the materials 32 and the module for modeling the impact 33.

The invention is not limited to the examples described and represented. In particular, the invention has been illustrated with examples of bird strikes on an airplane laminated glazing but it is clearly understood that it is applicable for any type of dynamic impact and any type of glazing comprising at least one glass sheet, whether it is a laminated glazing or not. An important condition for the correct implementation of the invention is the selection, in order to determine the fracture stress of a glass sheet, of a method representative of the stresses associated with the type of impact considered and of an appropriate definition of the fracture stress.

1. A nondestructive process for validating that a glazing installed in a structure withstands a dynamic impact, the glazing comprising at least one glass sheet, the process comprising:
with the aid of a finite-element numerical model of the glazing installed in the structure and subjected to the impact, using a law of behavior of the constituent material of each glass sheet, calculating a maximum stress envelope on at least one critical glass sheet of the glazing is calculated;
for at least the critical glass sheet of the glazing, comparing the maximum stress envelope to the fracture stress of the glass sheet obtained according to an experimental method for determining the fracture stress of a glass sheet selected as a function of the type of impact.

2. The process as claimed in claim 1, wherein the glazing is a laminated glazing comprising a stack of at least one glass sheet and one polymer interlayer, the process comprising:
with the aid of a finite-element numerical model of the laminated glazing installed in the structure and subjected to the impact, using a law of behavior of the constituent material of each glass sheet, a law of behavior of the constituent material of each polymer interlayer, and a law of behavior of each interface between a glass sheet and a polymer interlayer, calculating the maximum stress envelope on at least one critical glass sheet of the laminated glazing;
for at least the critical glass sheet of the laminated glazing, comparing the maximum stress envelope to the fracture stress of the glass sheet obtained according to an experimental method for determining the fracture stress of a glass sheet selected as a function of the type of impact.

3. A process for manufacturing a glazing so that it withstands a dynamic impact when it is installed in a structure, the glazing comprising at least one glass sheet, the process comprising:
with the aid of a finite-element numerical model of the glazing installed in the structure and subjected to the impact, using a law of behavior of the constituent material of each glass sheet, calculating a maximum stress envelope on at least one critical glass sheet of the glazing as a function of the dimensions of the glazing;
adjusting the characteristics of the glazing among its dimensions, and the constituent material of each glass sheet, so that the maximum stress envelope on at least the critical glass sheet of the glazing is strictly lower than the fracture stress of the glass sheet obtained according to an experimental method for determining the fracture stress of a glass sheet selected as a function of the type of impact, while having an optimized sizing of the glazing;
preparing and assembling each glass sheet of the glazing with the adjusted characteristics.

4. The process as claimed in claim 3, wherein the glazing is a laminated glazing comprising a stack of at least one glass sheet and one polymer interlayer, the process comprising:
with the aid of a finite-element numerical model of the laminated glazing installed in the structure and subjected to the impact, using a law of behavior of the constituent material of each glass sheet, a law of behavior of the constituent material of each polymer interlayer, and a law of behavior of each interface between a glass sheet and a polymer interlayer, calculating the maximum stress envelope on at least one critical glass sheet of the laminated glazing as a function of the dimensions of the laminated glazing;
adjusting the characteristics of the laminated glazing among its dimensions, the constituent material of each glass sheet, the constituent material of each polymer interlayer, and the nature of each interface between a glass sheet and a polymer interlayer, so that the maximum stress envelope on at least the critical glass sheet of the laminated glazing is strictly lower than the fracture stress of the glass sheet obtained according to an experimental method for determining the fracture stress of a glass sheet selected as a function of the type of impact, while having an optimized sizing of the laminated glazing;
preparing and assembling each glass sheet and each polymer interlayer of the laminated glazing with the adjusted characteristics.

5. The process as claimed in claim 1, wherein the finite-element numerical model is obtained by carrying out a meshing of geometric models of the impactor and of the glazing with its surrounding elements.

6. The process as claimed in claim 1, wherein the meshing of geometric models of the impactor and of the glazing and the calculation of the maximum stress envelope on each glass sheet of the glazing are carried out with the aid of finite-element analysis software.

7. The process as claimed in claim 1, wherein, provided as input, for the finite-element calculation, are the properties of the materials of the impactor, of the glazing and of the surrounding elements over at least the ranges of frequencies and temperatures characteristic of the impact.

8. The process as claimed in claim 1, wherein, provided as input, for the finite-element calculation, are the characteristics of the impact, which include a site and angle of impact of an impactor on the glazing, a relative speed between the glazing and the impactor, a mass of the impactor, and the temperature of each component.

9. The process as claimed in claim 1, wherein the method selected for determining the fracture stress of the glass sheet is a drop tower impact test, a ring-on-tripod flexural test without indentation or a ring-on-tripod flexural test after indentation.

10. The process as claimed in claim 1, wherein the glazing comprises at least one mineral glass sheet reinforced by chemical tempering and the method selected for determining the fracture stress of the glass sheet is a ring-on-tripod flexural test after indentation.

11. The process as claimed in claim 10, wherein an indentation depth is chosen as greater than the largest defect size of the glass and smaller than the compression depth resulting from the chemical tempering.

12. The process as claimed in claim 1, wherein the glazing is a laminated airplane glazing consisting of a stack of three glass sheets and two polymer interlayers inserted between the glass sheets.

13. The process as claimed in claim 1, wherein the glazing is a laminated helicopter glazing consisting of a stack comprising at least one glass sheet and one polymer interlayer.

14. The process as claimed in claim 1, wherein the glazing is a laminated glazing comprising a stack of at least one glass sheet and one polymer interlayer and the law of behavior of the constituent material of each polymer interlayer of the glazing is a viscoelastic model determined by carrying out the following steps:
establishing, from DMA results on a sample of the polymer interlayer, the curve of evolution of the storage modulus G′(f) of the material as a function of the frequency for various temperatures and the curve of evolution of the loss modulus G″(f) of the material as a function of the frequency for various temperatures;
from the data G′(f) and G″(f), constructing a master curve for the storage G′ and loss G″ moduli over at least the ranges of frequencies and temperatures characteristic of the impact, using for example the frequency/temperature equivalence law established by the WLF (Williams-Landel-Ferry) method;
identifying the parameters of the viscoelastic model of the constituent material of the polymer interlayer, by relating a Prony series to the master curve, in the form:
$$G ( t ) = {G}_{0} ( 1 - {\sum }_{k = 1}^{N} {g}_{k} ( 1 - {e}^{- \frac{t}{{τ}_{k}}} ) ) ,$$
with G₀ the instantaneous modulus, gₖ the relative moduli, and τₖ the relaxation times.

15. A glazing intended to withstand a given dynamic impact when the glazing is installed in a given structure, wherein the glazing is obtained by the process of claim 1.

16. (canceled)

17. A computer-readable recording medium whereon a computer program is recorded comprising instructions for executing all or some of the steps of a process as claimed in claim 1.

18. A terminal comprising a processing module configured for:
calculating, by finite element analysis, a maximum stress envelope on each glass sheet of a glazing installed in a structure and subjected to a dynamic impact, where the glazing comprises at least one glass sheet, with the aid of a finite-element numerical model of the glazing installed in the structure and subjected to the impact, using a law of behavior of the constituent material of each glass sheet, and
comparing the maximum stress envelope calculated for each glass sheet of the glazing to a fracture stress value of the glass sheet obtained according to an experimental method for determining the fracture stress of the glass selected as a function of the type of impact.

19. The terminal as claimed in claim 18, wherein the processing module is also configured for:
calculating, by finite element analysis, the maximum stress envelope on each glass sheet of the glazing as a function of the dimensions of the glazing, and
adjusting the dimensions of the glazing so that the maximum stress envelope calculated for each glass sheet of the glazing is strictly lower than the fracture stress of the glass sheet, obtained according to an experimental method for determining the fracture stress of the glass selected as a function of the type of impact, while having an optimized sizing of the glazing.

20. A system for validating, by finite element analysis, that a glazing installed in a structure withstands a dynamic impact, where the glazing comprises at least one glass sheet, the system comprising:
a graphical interface, configured for displaying models of an impactor and of the glazing with its surrounding elements, for providing input data for the finite element analysis and for displaying results of the finite element analysis;
a module for modeling the materials of the impactor, of each glass sheet of the glazing, and of the surrounding elements, in order to define the properties of these materials over at least the ranges of frequencies and temperatures characteristic of the impact;
a module for modeling the impact, in order to define in particular the site and angle of impact of an impactor on the glazing, the relative speed between the glazing and the impactor, and the temperature of each component;
a processing module, for preparing the finite-element numerical model of the glazing installed in the structure and subjected to the impact, carrying out the finite element analysis, and calculating the maximum stress envelope on each glass sheet of the glazing.

21. The system as claimed in claim 20, wherein the processing module uses the data defined in the module for modeling the materials and the model for modeling the impact.
